(19) United States
(12) Patent Application Publication
(10) Pub. No.: US 2007/0136183 A1
(43) Pub. Date: Jun. 14, 2007

(54) COMPUTER BASED MATCHING SYSTEM FOR BUYERS AND SELLERS

(76) Inventor: Mark Van Roon, Guelph, ON (CA)

Correspondence Address: SYNNESTVEDT LECHNER & WOODBRIDGE LLP, P O BOX 592, 112 NASSAU STREET, PRINCETON, NJ, 08542-0592, US

(21) Appl. No.: 11/678,199

(22) Filed: Feb. 23, 2007

Related U.S. Application Data
(63) Continuation of application No. 09/869,547, filed on Aug. 31, 2001.

(30) Foreign Application Priority Data
Dec. 29, 1998 (CA) 2,257,428
Dec. 29, 1999 (IB) PCT/IB99/02088

(51) Int. Cl. G06Q 40/00

(52) U.S. Cl. 705/37

(57) ABSTRACT

A computer based system is disclosed which enables a buyer and a seller to be efficiently matched. The system can comprise a web based foreign exchange platform in which parties and counterparties post their requirements. A computer identifies and matches reciprocal, offsetting positions and effects a trade at a price which is the mid-point of the Interbank bid/offer spread. The system is fast, efficient and fair, as well as being significantly cheaper than conventional foreign exchange systems.

### CROSS REFERENCE TO RELATED APPLICATIONS

This application is a continuation of U.S. application Ser. No. 09/869,547, filed Aug. 31, 2001, which claims the priority of Canadian application CA 2,257,428 filed 29 Dec. 1998 and PCT Application No. PCT/IB99/02088 filed on 29 Dec. 1999.

### BACKGROUND OF THE INVENTION

1. Field of the Invention

This invention relates to a computer based system which enables buyers and sellers to be efficiently matched, and in particular to an Internet based system which enables buyers and sellers to be efficiently matched. The invention is exemplified by a new business model and system for foreign exchange transactions.

2. Description of the Prior Art

The Internet offers the promise of enabling buyers and sellers of goods and services to communicate directly with one another, eliminating the need for some of the intermediaries and the associated economic inefficiencies present in conventional selling. Hence, for example, it is in 1998 possible to transact many kinds of business using the Internet, which formerly would have required a broker or agent. Examples include the purchase of insurance, airline tickets, books and holidays.

The Internet also enables new business models of buying and selling as well: for example, there are now many Internet auction sites, on which a wide range of goods and services are auctioned to the highest bidder, with the seller merely setting a reserve price or a bid start price. The terms to ‘buy’ and ‘sell’ and related expressions used in this specification should be broadly construed to include any kind of transfer of rights or interests; ‘buyers’ and ‘sellers’ should be also broadly construed to include any transferee and transferor of any kind of right or interest. The terms ‘party’ and ‘counterparty’ are commonly used to describe a situation in which a given party is both a buyer and simultaneously a seller. This can arise, for example, where a party wishes to exchange US$100 for the equivalent in Sterling. That party is simultaneously a seller of US$ and a buyer of Sterling.

Computer systems linking many potential buyers and sellers of goods and services over an extensive computer network also existed prior to the widespread adoption of the Internet, particularly in the financial services sector. One example is the foreign exchange dealing systems developed and run by organizations such as Reuters plc and the EBS Partnership. In these systems, banks post the prices at which they are willing to buy or sell defined quantities of currencies. The systems automatically spot matches—i.e. where a potential buyer is willing to buy at a price at which a potential seller is willing to sell—and complete the trade. If a potential buyer of currency can find no-one willing to sell at a price it considers low enough, then, typically, that potential buyer will simply have to either wait for the pricing in the market to become more favorable, or else be prepared to pay more. Such systems are commonly used for currency speculation, currency arbitrage, currency hedging, and currency procurement.

In addition to the need for speculative currency trading, there exists also a very substantial need for corporations to buy and sell foreign currency, for example, to pay overseas suppliers. Similarly, individuals traveling abroad or making foreign investments need to obtain foreign currencies as well. Currently, corporations and individuals will approach a bank or foreign currency vendor (such as American Express Inc.) to obtain foreign currency. The bank or foreign currency vendor will in turn often have obtained its stocks of foreign currency from other banks, in many cases having used an inter-bank trading system such as the Reuters or EBS systems. Because of the chain of intermediaries, the transaction cost of buying or selling foreign exchange in this way is quite high: this is reflected in the difference between the bid and the offer prices: a bank will typically sell foreign currency at a rate considerably higher than the rate at which it will buy it back. For small transactions, the difference can be 4% (400 basis points). For larger transactions, the difference is typically 5 basis points. (A basis point equals one-one hundredth of a ‘cent’ (percent) or, more simply, 100 basis points equals one cent). This difference between the bid and the offer is referred to as the ‘spread’.

### SUMMARY OF THE INVENTION

In accordance with a first aspect of the present invention, there is provided a computer based system which enables a party and a counter-party to be efficiently matched, comprising a first computer terminal into which the party inputs details of a potential transaction to acquire assets of type A in exchange for assets of type B, a second computer terminal into which the counterparty inputs details of a potential transaction to acquire assets of type C in exchange for assets of type D, a computer network connecting the first and second terminals; characterised in there being a computer program arranged to calculate directly or indirectly a mid-point price at which type A assets can be obtained in exchange for assets of type B.

Preferably, the mid-point price is the mid-point between (a) a price for exchanging type A for type B assets established by reference to data substantially independent of the party and the counterparty and (b) a price for exchanging type B for type A assets, established by reference to data substantially independent of the party and the counterparty. In a simple bi-lateral situation, asset type C is the same as asset type B and asset type D is the same as asset type A. In more complex situations, 2 or more parties/counterparties may be involved and the asset pairs associated with each party (i.e. asset required and asset available) may not match the asset pairs from any single other counterparty. Hence, in the broadest statement of the first aspect of the invention, the asset pair of the counterparty is given a different denomination (‘C’ and ‘D’) from the party asset pair (‘A’ and ‘B’). An example of how this situation can be resolved in a specific embodiment is given in the Detailed Description section of this specification (see section describing the ‘netting hybrid’ illustrated at FIGS. 2A, B and C). The specified details of the potential transaction will typically include at least the amount of the owned asset which is available for exchanging and the kind of different asset type actually sought, or the amount and kind of the asset required and the kind of asset available for exchange.

Preferably, it is possible to complete the transaction at the mid-point price. Then, a fee can be charged to either the party and/or the counterparty by the system provider. Alternatively, it is also possible to use the ‘spread’ concept, but with the spread measured from the mid-point.

Examples of possible ways in which spreads can be derived using mid-points include, without limitation: (a) midpoint price plus a uniform percentage spread around the midpoint/mean for each of the parties to a transaction; (b) midpoint price plus a uniform basis point spread around the midpoint/mean for each of the parties to a transaction and (c) a standard spread or series of spreads reduced to either a uniform percentage spread or a uniform basis point spread around a midpoint/mean.

By arranging for trades to use the mid-point price (for example as the actual deal price or as the base for determining a spread) defined by reference to selling and purchase prices determined independently of the buyer and seller, the system can automatically match buyers and sellers in a manner which is both fast, efficient, transparent and fair. Speculation and the taking of trading positions, which are defining characteristics of conventional computer based systems for buying and selling products such as foreign exchange, are reduced in the present invention. The present invention may also be seen as reducing the possibility of price fixing and other anti-competitive behavior. The user functionality may include any series of operations, the limiting factor of which is the execution by two or more parties at the mid-point price or some variation which uses the mid-point price.

The Internet may comprise some of the network connecting the first and second terminals. The terminals may then operate as clients. The terminals may in any event be any kind of wired or wireless information device, including PCs, cellular telephones, smart phones and communicators.

In one embodiment, it is the sale or transfer of financial property, such as foreign exchange (“FX”), treasury bills, and stocks and shares, which is matched as between buyers and sellers. The term ‘financial property’ is used in this patent specification to embrace any and all financial products which are traded by financial institutions, and therefore includes, without limitation, derivatives, options, debentures, bonds as well as the foreign exchange, treasury bills, and stocks and shares referred to above.

For foreign exchange, the mid-point may be determined as the mid-point of the Interbank Bid/Offer (B/O) spread at a specific point in time. More specifically, it may be the mid-point of a number of different prices, including, without limitation, (a) the Interbank highest bid, lowest offer, (b) the Interbank most recent traded price, (c) the Interbank highest bid, lowest offer by subset of largest market makers in any particular currency and (d) the highest bid, lowest offer in the most liquid market. A ‘bid’ price is the price a buyer is willing to pay for an asset or, alternatively, the price at which a seller is able to liquidate his asset. An ‘offer’ price is the price a seller is willing to be paid for his asset or, alternatively, the price at which a buyer may purchase an asset. The bid/offer spread is typically the most accepted method of price discovery in a liquid market. In the preset invention, the mid-point price is typically calculated against a base currency, generally the US Dollar. Hence, if a party wishes to obtain Japanese Yen (JPY) in exchange for British Sterling, then the mid-point used in the calculation is the product of the midpoint price of USD/JPY and the midpoint price of GBP/USD or, more simply, midpt(USD/JPY)×midpt (GBP/USD)=midpt (GBP/JPY). Because virtually all live currency pricing is findamentally based on USD exchange value, the present system also adopts that approach. USD can be thought of as a ‘base’ or common asset. The present system can therefore be used to calculate any currency rate either ‘directly’ against the base currency or ‘indirectly’ against any other currency via a relationship with the base currency.

In the present invention, the price is typically not negotiable as it is in a dealing system with posted desired rates. This is not to imply that the embodiments of the present invention cannot or will not permit price limits as a user defined finction. Parties do, however, typically accept the midpoint of the posted Interbank (or other defined) spread at a specific time as the most desirable position at which to exchange their currency (and, optionally, on which a spread may be positioned) since it affords them the greatest quantity of counter-currency at any given point in time—assuming and to the extent they can be matched. In the event that no match can be found using the present system, either no deal is done or a deal is done along a default Interbank system at the appropriate bid or offer point.

Bankers traditionally invest considerable time and expertise in setting foreign exchange rates, applying a complex multi-factorial analysis involving an intimate understanding of relative currency stabilities. The present invention as applied to FX in effect appropriates this expertise and makes the product of that expertise widely available to enable a fast, efficient, transparent, fair and cheaper FX process.

Because this system facilitates the direct matching of counterparties, the reduction of settlement risk is a potential advantage. Where this advantage is realised, global foreign currency settlement risk is reduced.

In another embodiment, the system handles the sale of contractual rights; and in a further embodiment, the sale of tangible property.

In a second aspect of the present invention, there is provided a computer based system which enables a party and a counterparty of financial property to be efficiently matched, comprising a first computer terminal into which the party inputs details of a potential first transaction, a second computer terminal into which the counterparty inputs details of a potential reciprocal transaction which is in whole or part reciprocal to the potential first transaction, and a computer network connecting the first and second terminals; characterised in that the party and the counterparty are either corporations including financial institutions and/or individuals.

Conventionally, corporate or individual buyers and sellers of financial property have necessarily traded in financial property using the intermediary of a financial institution. As noted above, the presence of such intermediaries results in additional cost burdens being placed on corporate or individual buyers and sellers, which is economically inefficient. Those inefficiencies are eliminated with direct trading of financial property as envisaged in the present invention between corporate or individual buyers and sellers.

In a further aspect, there is provided a method of obtaining foreign exchange for a party, comprising the steps of:
(i) the party defining a foreign exchange requirement using a web browser;
(ii) sending the requirement via the internet to a server; and
(iii) processing that requirement in relation to a mid-point between a bid price and an offer price, each price established by reference to data substantially independent of the party.

In another aspect, there is a method of computing the amount of foreign exchange available to a party comprising the steps of:
(i) receiving from the party a foreign exchange requirement; and
(ii) processing that requirement in relation to a mid-point between a bid price and an offer price, each price established by reference to data substantially independent of the party.

In a penulitmate aspect, there is a server programmed to process a requirement for foreign exchange to be supplied to a party, using a mid-point between a bid price and an offer price, each price established by reference to data substantially independent of the party.

In a final aspect there is a computer terminal acting as a client, in which the client accepts from a party a foreign exchange requirement and sends that requirement to a server as defined in the preceding paragraph.

### BRIEF DESCRIPTION OF THE FIGURES

The invention will be described in more detail with reference to:

FIG. 1 which is a diagram representing the bid/offer pricing for USD priced in CAD;

FIGS. 2A, 2B and 2C which is a table showing how a FX “netting hybrid” system can operate in conjunction with the present invention;

FIGS. 3A and 3B, which are schematic depictions of a computer based system according to this invention which enables buyers and sellers of foreign exchange to be efficiently matched; and

FIG. 4, which is a schematic representing the key steps in the inventive system as applied to FX matching.

### DETAILED DESCRIPTION OF THE PREFERRED EMBODIMENT

The fundamental innovation of calculating and using, for a transaction between a specific party and counterparty, a mid-point price calculated using the best sell and buy prices established by a market (and which are therefore independent of the specific buyer and seller) can be used in many conventional business models. The skilled implementer will therefore readily appreciate that this innovation can be applied to many different conventional systems, whether web-based or requiring personal interaction (such as telephone brokerage systems). For example, web-based or telephone based stock/share trades could be offered on the basis of both the conventional ‘best available buy or sell, plus charges’, or alternatively, at the mid-point, plus significantly lower charges. Very often, the latter will offer the best overall value. Adapting a conventional web-based or telephone system to calculate the mid-points and (if relevant) determine a spread about the mid-point, is readily achieved once access to the raw data from which the mid-points are calculated. In addition, a central data provider, such as a Reuters or Bloomberg, could calculate the mid-points, and include these in their data. Because the implementation of such an adapted, conventional system is clearly within the competence of the skilled implementer, no detailed description of such a system is included in this specification.

Moving from the more conventional applications of the present inventive, business concept, a more demanding application of the present invention is an entirely Web based system for enabling FX to be matched and transferred. Such a system will be described in detail.

Currently, banks broker foreign exchange transactions, providing an intermediary to purchase and sell currency for both their and their clients′ accounts. For each transaction the bank garners the “spread”, typically 5 basis points on large transactions and up to 4% (400 basis points) on smaller transactions.

In an embodiment of the present invention, the appropriate underlying transactional software allows one end user of the foreign exchange (e.g. a first corporation, Corporation A, doing a cross border procurement) to liaise directly or indirectly with a counterparty, a second corporation, Corporation B, which requires the home currency of Corporation A. The bank brokering function can be eliminated: that is, the spread currently absorbed by the two sample corporations would be negated, or based on a more transparent spread using a mid-point price established using posted Interbank rates. Where the spread is entirely eliminated, each party to a transaction where the quoted spread was 5 basis points, would therefore improve their cash position by 2.5 basis points. For smaller customers the savings would be even greater.

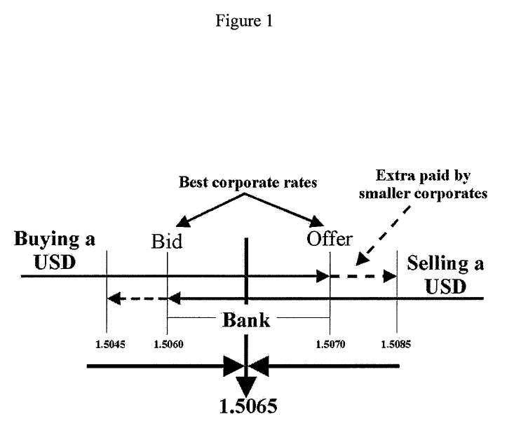

FIG. 1 illustrates this principle: the best corporate rates for exchanging CADollars for USDollars are shown: the highest bid price for a potential seller of USD for CAD is 1.5060 CAD and the lowest offer price for a potential buyer of USDollars for CAD is at 1.5070 as shown i.e. if one wants to buy a USDollar it would cost 1.5070 CAD and if one wants to sell a USDollar, one would receive 1.5060 CAD in return. Therefore, 1.5060/70 is the bid/offer spread for USD to CAD in this example.

These are the rates available to major corporates handling high volume transactions. The prices for smaller companies will be far less favourable. The mid-point price of 1.5065 CADollars to the USDollar offers an in principle saving of 5 basis points, or 500 per USD1Million exchanged. For smaller companies, who can most benefit from the present invention, the percentage savings would be greater still.

Moreover, transactions can be executed in a multitude of dimensions: two way; three way; four way; etc, since the software would expose the transactional opportunities available to each of the clients.

The overall system approach can best be understood through a sample problem:

Sample Problem

Imagine the following:
1. That the spot price of CDN$ is US$ 1.5363-1.5373 at Nov. 27/98.
2. That Corporation A is buying US $1M to purchase equipment at a cost of CDN $1,537,300.00. Corporation A. has CDN $1,536,800.00 on account with a bank for the transaction (note: this assumes that the bank provides the best rate to Corporation A).
3. That Corporation B has US$1M on account with the bank but requires CDN$1,536,300.00 to purchase raw materials.

If the bank matches its own funds to supply Corporation A with US$1M and Corporation B with CDN$1,536,300.00, then it makes a profit of $1,000.00 per $million transacted. Although $1,000 is a very small amount in the context of a significant $1M transaction, the total global volume of such transactions is extremely large, so that the cumulative profits to banks are very substantial.

In the present invention, the following occurs: Corporation A and B agree before transacting that they will do so at an exchange rate that is the mid-point of the posted Interbank rate, for example, the Interbank highest bid, lowest offer at the appropriate time. This is a fair compromise for each participant. Hence, the transaction can be completed automatically, rapidly and efficiently. The party and counterparty each deposit the funds needed to execute a transaction with a financial institution; the funds are preferably pre-cleared and are not marginable through the system. A sophisticated computer program determines that the party and counter-party are taking reciprocal positions, which can be matched against each other and instructs the relevant financial institutions to transfer the required foreign exchange as, in effect, a swap. By matching Corporation A with Corporation B, each of their positions is improved by $500.00 per million, less a transaction fee to an intermediary of perhaps $50.00 per side. The result is that Corporation A receives US$1M for $1,536,750 per million; a saving of $450.00 per million; Corporation B Receives $1,536,850 for US$1M; an improvement in profit of $450.00. The system has in effect reduced the spread to 1 basis point. The spread can theoretically be reduced to just short of zero since the present invention operates efficiently and automatically. This example works because of the exactly matching reciprocal requirements of the parties. In practice, that will rarely happen and some sort of netting will be required. The exact details of the netting process, whilst outside of the scope of the present invention, are included here for clarity and completeness.

The fundamental netting concept applied in this embodiment is that a computer is programmed with information relating to a party and counterparty transaction, to determine a net payment position if both the first and second transactions occur and to actually complete each transaction on the basis of the net payment position.

This approach can be contrasted with conventional netting, in which a transaction is completed and only subsequently does netting occur to reduce the number and size of payments. Typically, there might be several party/counterparty pairs in a connected series of transactions in the present embodiment.

### Multilateral Netting Example

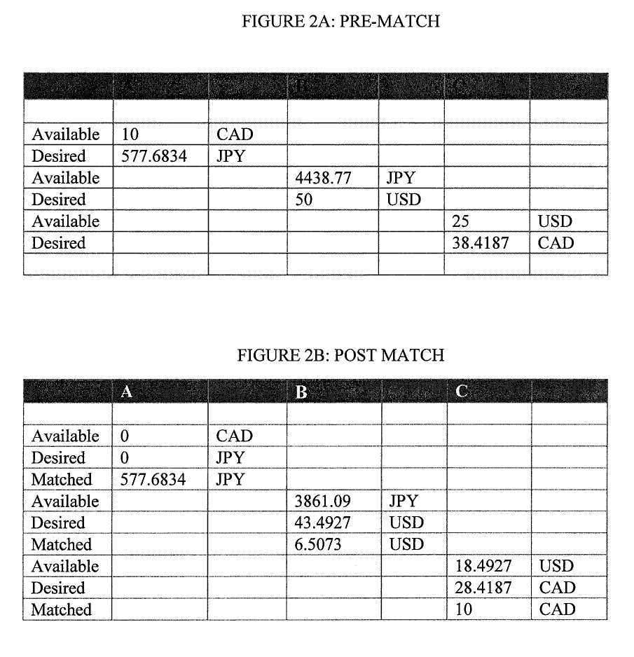

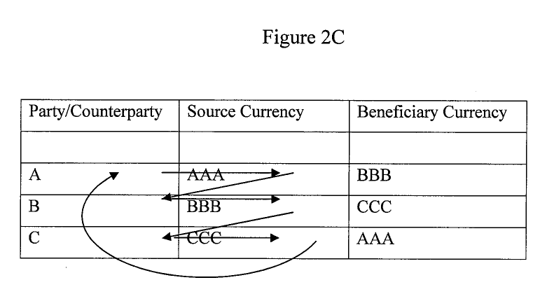

In the present system, it will be seen that the netting step is not simply a stage subsequent to but independent from the underlying exchange transaction, performed for accounting simplicity to reduce the numbers and sizes of cross-payments. Instead, it is an integral part of the underlying exchange transaction between party and counterparty. This is most clearly emphasized when considering a multi-party exchange of currencies. Take, for example, a situation in which there are 3 Corporations—A, B and C . A has CAD and needs JPY; B has JPY and needs USD; C has USD and needs CAD. The exact needs are shown in FIG. 2A. A cannot satisfy its requirements in whole or in part by dealing with B exclusively. However, if C can be “linked” into the transaction, all three corporations can be satisfied to the value of the smallest available currency.

We assume that the mid-point of Interbank B/O at a point in time is as follows: 1.53675 CAD; 1 USD; 88.7755 YEN; (i.e. all numbers are relative to the USD base currency).

The desired amounts indicated on FIG. 2A reflect the mid-market value of the available currency. The post-match situation using this embodiment is shown on FIG. 2B.

It will be noted that the limiting factor in this match example was the availability of CAD for JPY.

The embodiment uses a “currency link” to match partially or fully the desired quantities of the match. A currency link is created using the source currency and the beneficiary (desired) currency for a series of transactions. FIG. 2C illustrates a simple three-way currency link.

Note, that if, for example, Party C wanted a currency other than AAA, say DDD, there would not be a currency link from which to synthesize a transaction.

A link is therefore defined as (A to B; B to A); or (A to B; B to C; C to A); or (A to B; B to C; C to D; D to A) etc. A mathematical relationship at a point in time therefore exists between the currencies. Another example is A to C, B to A and C to B.

The distinction from traditional netting programs is three-fold. First, netting in the present embodiment happens in real-time, not at a fixed point in time post transaction for various parties, none of which are necessarily the same from one “link” to the next, and consequently, from one “match” (whole or partial) to the next. Second, the program is designed to seek out the “currency linking” in ascending order of the number of potential counter-parties. As complete matches occur (as in A above), the matched party drops out of the matrix. The program seeks out the next currency links based on a set of transactions rules to fulfill wholly or partially the next match. Third, traditional netting occurs on completion of a series of transactions. For example, if Party A is obligated to pay Party B three units of a currency and Party B is obligated to pay Party C three units of a currency, a netting transaction would have Party A pay Party C three units of currency directly. In this embodiment, transactions are synthesized by matching source (available) currency to beneficiary (desired) currency requirements. As such the transaction could be deemed a “netting hybrid”.

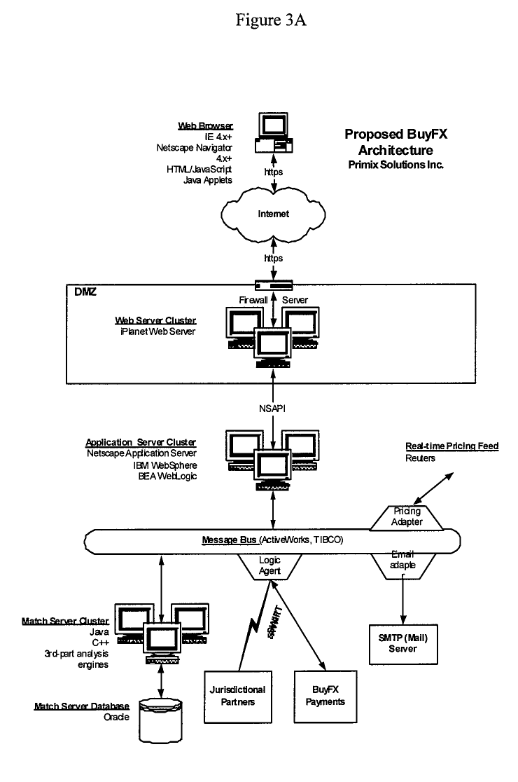

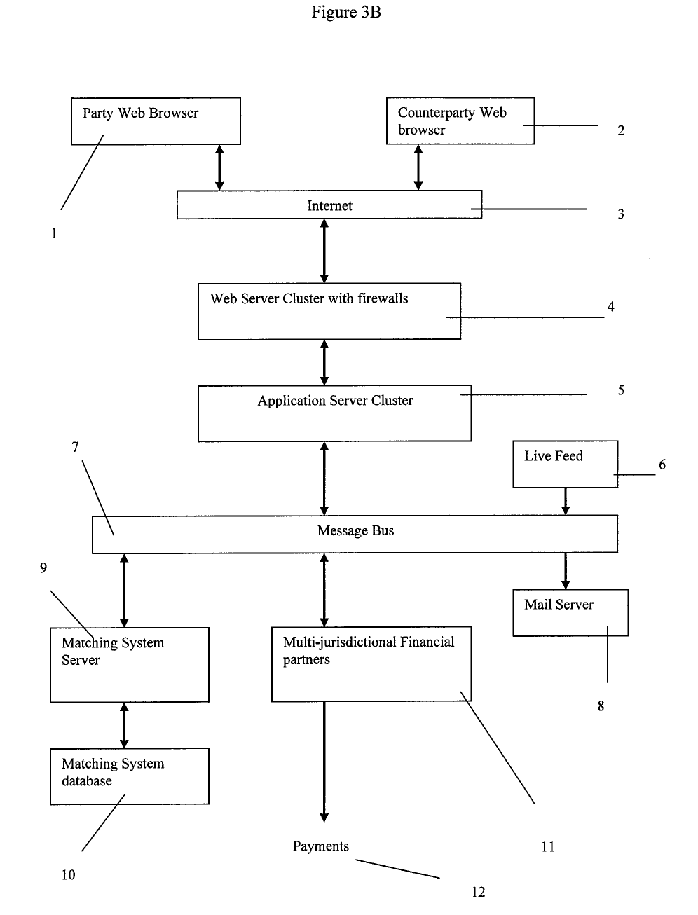

The present system may be further understood with reference to FIGS. 3A and 3B, which each show a schematic of the major elements in a foreign exchange matching system in accordance with the present invention. FIG. 3A is an actual proposed architecture schematic for an FX embodiment prepared by Primix Solutions Inc; the embodiment is called ‘BuyFX’. The functions of the major blocks in FIG. 3A and 3B are the same and are as follows: the party and counterparty each interact with the foreign exchange matching system using their web browsers (1, 2), which communicate via the Internet 3 with a conventional Web cluster/firewall 4 connected to an application server cluster 5 running Netscape Application Server, IBM WebSphere or BEA WebLogic. Cluster 5 is connected to a message bus 7, such as ActiveWorks or Tibco. The message bus 7 is connected to a live data feed 6, which provides continuous and up to date pricing information. A Reuters or Bloomberg feed could be used. Message bus 7 is also connected to a mail server 8 which communicates with various entities, including the party and counterparty.

Message bus 7 is also connected to the matching system server 9, which runs a Java or C++ program calculating not only the mid-point prices (and related spreads, if applicable) using data from the live feed 6 but also identifying where netting opportunities exist to enable a currency match to occur and the nature of the netting. Matching System server 9 is connected to an Oracle database 10. Message bus 7 is connected to the various system financial partners 11 (typically one, but not limited to one, in each jurisdiction whose currency is available for matching through the system). These are typically banks or deposit taking institutions. These partners actually take the payment from and make payments 12 to each party and counterparty in the amounts defined by the matching system server 9.

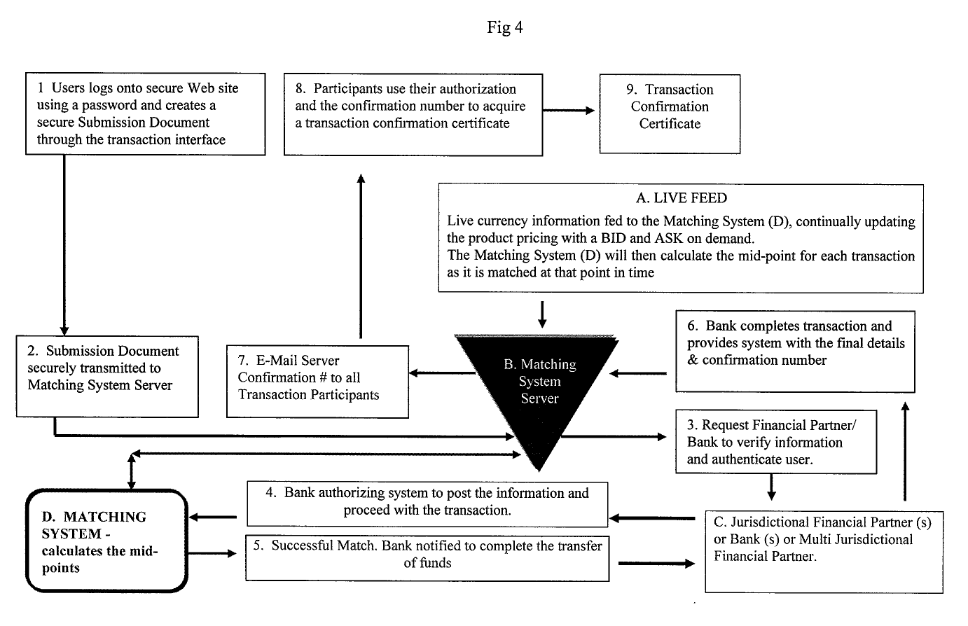

Reference should now be made to FIG. 4, which is a step by step walk through the process. FIG. 4 includes, but is not limited to, the denoted steps to execute a transaction. At step 1, a party with a need for foreign exchange logs onto a secure web site using its browser. Initially, the party has to complete a customer profile and user authentication. This involves the following steps: On entering the secure FX Matching System web portal, the customer has to:
(A) Register with the FX Matching System and its jurisdictional banking partners in a secure environment (if a new user), or
(B) Authenticate its identity with a user name and password (if an existing user).
(C) If a new user, it also has to enter various administrator-defined restrictions-user restrictions, currency restrictions, volume restrictions e.g. User “XXXX” can transact in currency “XXX” and “YYY” only, in volumes not to exceed “XXXXXX”.

Once authenticated as a user, the customer will be able to complete a secure submission document using its Web browser (Step 1). This document enables a user to:
(A) List, in a secure environment, commonly used source accounts and beneficiary accounts.
(B) Enter an electronic funds transfer request, with funds moving from a source account to a beneficiary account at a jurisdictional banking partner, if necessary.

Once its funds have been deposited and the cleared funds are “held” by a jurisdictional banking partner, the customer is able to ‘post’ funds using the browser based submission document as follows:
(A) By requesting a conversion on a defined source amount (e.g. the customer has a source quantity of $1M USD which it requires to be converted to CAD), or
(B) By requesting a beneficiary amount, the computer program will calculate the quantity of source funds required, utilizing a “buffer percentage” to account for potential currency fluctuations. The “buffer percentage” is a convenience feature for customers and will be calculated on a currency specific basis at two standard deviations of the daily fluctuation of the currency.

The secure submission document also allows each user to define the kind of transaction required. Examples of user-defined functionality include, but are not limited to, the following:
(A) ‘Match’—the exchange transaction is completed as and when reciprocal funds become available in whole or in a series of partials for a customer to fulfil a currency order; this process can be time-sensitive. Implicit in the Match order is end of day execution of any unfilled balances, unless the customer has his own beneficiary account and elects to bypass that option;
(B) ‘Match (All or none)’—the exchange transaction is completed only as and when a complete block of currency (as a series of partials or in one reciprocating block) becomes available to fulfill a currency order; (again, this can be time-sensitive);
(C) ‘Match and Market (M & M's)’—a time sensitive order to fill the customer currency requirement with as much “matched” currency as is available during a user-defined period of time, with the option of executing the balance at the prevailing market rate with a banking partner or financial institution;
(D) ‘Market’—an order allowing a customer to bypass the matching process and go directly to a jurisdictional partner for execution; this can be time-sensitive;
(E) ‘Special Liquidity’—certain corporate partners, and, in some circumstances, regular customers will be able to submit orders at preferred rates to augment liquidity. “D-SL” orders never have precedence over regular “Direct” orders.

The Submssions Document is then securely transmitted (step 2) to the Matching System Server (B). The Matching System Server (B) then requests (step 3) the appropriate financial institution (C) to verify the information given by the party (including the availability of funds) and to authenticate the user from the financial institution's perspective. An account held with this multi jurisdictional financial partner(s) serves nothing but a transactional purpose through which funds are matched and distributed. The multi jurisdictional financial partner(s) accepts funds on account in the currency by which they were deposited. Correspondingly, this institution delivers funds to the customer in the beneficiary currency at the prescribed rate of exchange. All currency exchange is electronic so that no physical securities are required for clearing.

Once the financial institution (C) has confirmed that the user has the required funds to be exchanged it in effect freezes those funds, and then authorises the matching system (step 4) to post the required information and proceed with the transaction. The Matching System (D) then performs the netting identification process illustrated at FIG. 2B, using the mid-point prices it calculates using the data from live feed (A). Matching System (D) uses the following order prioritisation feature. In order to prevent one company and/or transaction from “locking out” other customers by placing a substantial order in relation to the available liquidity, customers will be able to place orders to a maximum size of “X” USD equivalent. The software will accept volumes in excess of this size. These will be automatically processed into a series of smaller transactions, determined by the Matching System (D) and contingent on the liquidity of the currency. Execution of these smaller transaction volumes will occur in sequence with the initial block being completed on a “first in, first out”, followed by the next Matching System (D) customers in that currency, if any, on a FIFO basis; followed by the second block from the transaction; followed by the next customers in that currency, if any, and so on until the cumulative volume is filled. This prevents one customer from monopolizing any one currency to the detriment of other customers.

Where a successful match has occurred, the Matching System (D) notifies the various financial institutions to complete the funds transfer. More exactly, transactions are aggregated by Matching System (D), reconciled, and recorded to one central file per jurisdictional financial institution. The “batched” files are transmitted to the jurisdictional partner (step 5).

Notification arises through the Matching System (D) issuing an ‘International Payment Instruction’. This is an order to a financial partner to record payment instructions to a customer defined beneficiary account;

Issuance of the ‘International Payment Instruction’ will occur under, but will not be limited to, the following conditions:
(A) When a customer is “matched” fully
(B) When a customer is filled at the end of the day
(C) When a “Match and Market” order has been fulfilled.
(D) If customer selects “Market” or “Match (All or none)” order.
(E) If a customer elects to carry an order over a number of days, until that order is filled in its entirety, the direction to pay option to a Payee Account remains unavailable. In that circumstance, the customer must maintain his own beneficiary account.

In addition to handling International Payment Instructions, the system can equally well handle Domestic Payment Instructions—for corporations who seek to transfer funds domestically.

In addition to issuing the International Payments Instruction, the Matching System (D) records the transaction details and time-stamps them. Pricing is also screened by the Matching System (D) for anomalous trades to ensure transaction integrity. Matching System (D) also causes an e-mail customer notification of a match to be issued, pending final payment and settlement.

Payment instructions are then confirmed, aggregated, and reconciled at the financial partner. Payment is subsequently effected (step 6) to the denoted beneficiary accounts (payee or customer). Each jurisdictional banking partner will release funds at the earliest available opportunity after the daily batching function. Confirmation details are recorded for transmission to customers; confirmation email and online transaction reporting details are transmitted to each customer (step 7). Call centre functionality allows customer to gain transaction details should their ISP be experiencing technical details. At step 8, each customer can obtain a transaction confirmation certificate (Step 9). The transaction is now fully completed.

There are various additional aspects to the FX Matching System which are not illustrated. For example, a product for individuals (business travelers) is available; as is a corporate wholesale product for intermediary exchange requirements; and a “market” product for blue-chip multinationals. The transaction size in these incarnations may dictate the transactions “fee” for executing a currency match; the program could, but does not have to automatically categorize the trade into the appropriate product with the appropriate rate scale.

A hedging facility for foreign exchange exposure may also be included, in which matched forwards can be offered by the jurisdictional financial partner.

In addition, exposure positions are available to the multi jurisdictional financial partner(s) to mitigate systematic risk with one another.

The system can be implemented as a series of scalable products available for distribution through many different channels through the Internet; the customer may enter the system directly through the denoted web site to transact; the customer may enter via the web site of our multi jurisdictional partner(s) in a co-branded product, or the customer may enter via the web site of a multi jurisdictional partner in a “partner-branded aka white-branded” or non-branded interface. For the retail individual, an affiliation between the present system and a courier and travelers cheques company is possible. This enables a transaction to be completed anywhere in world with the traveler's cheque couriered directly to the individual. This is envisaged as a premium service delivered via the Internet.

As explained above, the system can provide cross-border settlement of accounts, converted to the currency of choice, at exchange rates that represent the closest to fully efficient currency markets. This is particularly advantageous for the small/medium corporate user.

1. A computer based system which enables a party and a counter-party to be efficiently matched, comprising a first computer terminal into which the party inputs details of a potential transaction to acquire assets of type A in exchange for assets of type B, a second computer terminal into which a counterparty inputs details of a potential transaction to acquire assets of type C in exchange for assets of type D, a computer network connecting the first and second terminals; characterized in there being a computer program arranged to calculate directly or indirectly using real time pricing data a mid-point price at which type A assets can be obtained in exchange for assets of type B.

2. The computer based system of claim 1 in which the mid-point price is the mid-point between (a) a price for exchanging type A for type B assets established by reference to real time data substantially independent of the party and the counterparty and (b) a price for exchanging type B for type A assets, established by reference to real time data substantially independent of the party and the counterparty.

3. The computer based system of claim 1 in which the mid-point price is calculated using the mid-point between the price at which type B assets can be obtained in exchange for a base asset and the reciprocal transaction in which the base asset is exchanged for type B assets.

4. The computer based system of claim 3 in which the indirect calculation of the mid-point price at which type A assets can be obtained in exchange for assets of type B involves calculating (i) the mid-point between the price at which type B assets can be obtained in exchange for a base asset and the reciprocal transaction and (ii) the mid-point between the price at which type A assets can be obtained in exchange for a base asset and the reciprocal transaction.

5. The computer based system of claim 1 in which asset type C is the same as asset type B and asset type D is the same as asset type A.

6. The computer based system of claim 1 in which the transaction relates to foreign exchange such that the type A asset is currency in one denomination, type B assets is currency in another denomination and the mid-point is selected from one of the following:
(a) the Interbank highest bid, lowest offer;
(b) the Interbank most recent traded price;
(c) the Interbank highest bid, lowest offer by subset of largest market makers in any particular currency; or
(d) the highest bid, lowest offer in the most liquid market.

7. The computer based system of claim 1 in which a spread is derived using the calculated mid-point.

8. The computer based system of claim 7 in which one of the following spreads is used:
(a) a uniform percentage spread around the midpoint/mean for each of the parties to a transaction;
(b) a uniform basis point spread around the midpoint/mean for each of the parties to a transaction or
(c) a standard spread or series of spreads reduced to either a uniform percentage spread or a uniform basis point spread around a midpoint/mean.

9. The system of claim 1 in which the Internet forms part of the computer network.

10. A computer based system which enables a party and a counterparty of financial property to be efficiently matched, comprising a first computer terminal into which the party inputs details of a potential first transaction, a second computer terminal into which the counterparty inputs details of a potential reciprocal transaction, and a computer network connecting the first and second terminals; characterized in that both the party and the counterparty is either any corporation or individual.

11. A method of obtaining foreign exchange for a party, comprising the steps of:
the party defining a foreign exchange requirement using a web browser; sending the requirement via the internet to a server; and
processing that requirement in relation to a mid-point between a bid price and an offer price, each price established by reference to real time data substantially independent of the party.

12. A method of computing the amount of foreign exchange available to a party comprising the steps of:
(i) receiving from the party a foreign exchange requirement; and
(ii) processing that requirement in relation to a mid-point between a bid price and an offer price, each price established by reference to real time data substantially independent of the party.

13. A server programmed to process a requirement for foreign exchange to be supplied to a party, using a mid-point between a bid price and an offer price, each price established by reference to real time data substantially independent of the party.

14. A computer terminal acting as a client, in which the client accepts from a party a foreign exchange requirement and sends that requirement to a server as defined in claim 11.

15. The method of claim 11 in which the mid-point is selected from one of the following:
(a) the Interbank highest bid, lowest offer;
(b) the Interbank most recent traded price;
(c) the Interbank highest bid, lowest offer by subset of largest market makers in any particular currency; and
(d) the highest bid, lowest offer in the most liquid market.

16. The computer based system of claim 15 in which a spread is derived using the calculated mid-point.

17. The computer based system of claim 16 in which one of the following spreads is used:
(a) a uniform percentage spread around the midpoint/mean for each of the parties to a transaction;
(b) a uniform basis point spread around the midpoint/mean for each of the parties to a transaction or
(c) a standard spread or series of spreads reduced to either a uniform percentage spread or a uniform basis point spread around a midpoint/mean.
